(19) United States
(12) Patent Application Publication
(10) Pub. No.: US 2026/0008069 A1
(43) Pub. Date: Jan. 8, 2026

(54) ROTARY NOZZLE WITH DATA LOGGER

(71) Applicant: STONEAGE, INC., Durango, CO (US)

(72) Inventor: Joseph A. SCHNEIDER, Durango, CO (US)

(21) Appl. No.: 19/258,295

(22) Filed: Jul. 2, 2025

Related U.S. Application Data
(60) Provisional application No. 63/667,469, filed on Jul. 3, 2024.

(51) Int. Cl. B05B 3/06; B05B 3/10; B05B 12/00

(52) U.S. Cl. CPC B05B 3/06; B05B 3/1085; B05B 12/004

(57) ABSTRACT

A nozzle assembly with a data logger. The nozzle apparatus assembly comprises a housing body and a tubular nozzle shaft coupled to a nozzle head. The tubular nozzle shaft and the nozzle head define a portion of a fluid pathway extending from an inlet end of the housing body to a set of directional nozzles. The tubular nozzle shaft and the nozzle head are configured to rotate together in response to a discharge of a pressurized liquid from the set of directional nozzles. A data logger housed within the housing body includes a rotation sensor configured to detect rotation of the tubular nozzle shaft or the nozzle head, a data storage device configured to store rotation data captured by the rotation sensor or rotational speed data calculated from the rotation data and time data, and a communications interface configured to transmit the stored data to a remote computing device.

### CROSS-REFERENCE TO RELATED APPLICATION

This application claims the benefit of U.S. Provisional Application No. 63/667,469, filed on Jul. 3, 2024, entitled “Rotary Nozzle With Data Logger,” the technical disclosures of which is hereby incorporated by reference in its entirety.

### BACKGROUND

### Technical Field

Novel aspects of the present disclosure relate to the field of high-pressure fluid spraying applications, and more particularly to a rotary nozzle assembly having a data logger capable of capturing, storing, and transmitting operational data to a remote computing device for optimizing use of the rotary nozzle assembly.

### Background

Conventional high-pressure rotary liquid handling devices, i.e., rotary nozzles, can have operating parameters that include pressures exceeding 44,000 pounds per square inch (PSI), rotating speeds exceeding 5,000 revolutions per minute (RPM), and flow rates that exceed 25 gallons per minute (GPM). At these high pressures and flow rates, the nozzle heads of these rotary nozzles can rotate at high speeds. In many applications, such as surface preparation or cleaning operations, it is desirable to slow the rotational speed of the nozzle heads to improve its cleaning efficiency and to increase its service life, and to capture operational data that can improve the operation of the rotary nozzle.

These rotary nozzles are frequently used by municipalities across the world for sewer cleaning applications, either as a part of a preventative cleaning strategy or a reactionary cleaning strategy in response to known blockages. In either instance, municipalities have indicated a desire to be able to formulate protocols for sewer cleaning, which specifies guidelines such as pressure and flow rate from their water trucks, rotary nozzle choice and associated operating parameters, service intervals for the rotary nozzle, etc. Rotary nozzles are also used by waterblast contractors for cleaning applications of industrial equipment and the like, but less frequently than sewer cleaning operators. However, similar decisions regarding tool choice, operating parameters, and service intervals still apply. In the absence of accurate operational data collected during actual use of the rotary nozzle, these decisions are based on conjecture.

### SUMMARY OF THE INVENTION

Novel aspects of the present disclosure are directed to a nozzle apparatus assembly with a data logger. The nozzle apparatus assembly comprises a housing body, a tubular nozzle shaft rotatably mounted within the housing body, and a nozzle head coupled to the tubular nozzle shaft. The tubular nozzle shaft and the nozzle head define a portion of a fluid pathway extending from an inlet end of the housing body to a set of directional nozzles disposed at a discharge end of the nozzle head, and the tubular nozzle shaft and the nozzle head are configured to rotate together in response to a discharge of a pressurized liquid from the set of directional nozzles. The nozzle apparatus assembly also includes a data logger housed within the housing body, which includes a rotation sensor configured to detect rotation of the tubular nozzle shaft or the nozzle head, data storage configured to store rotation data captured by the rotation sensor or rotational speed data calculated from the rotation data and time data, and a communications interface configured to transmit the stored data to a remote computing device.

Other novel aspects of the present disclosure are directed to a data logger for capturing operational data of a nozzle apparatus assembly. The data logger comprises a printed circuit board (PCB), a rotation sensor disposed on the PCB and configured to detect rotation of the tubular nozzle shaft or the nozzle head, and a microcontroller disposed on the PCB and communicatively coupled to the rotation sensor. The microcontroller is configured to calculate rotational speed data based on signals from the rotation sensor. The data logger also includes data storage disposed on the PCB and configured to store the rotational speed data, and a communications interface disposed on the PCB and configured to transmit the rotational speed data to a remote computing device.

Other aspects, embodiments and features of the invention will become apparent from the following detailed description of the disclosure when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the novel aspects of the disclosure.

### BRIEF DESCRIPTION OF THE FIGURES

The novel features believed characteristic of the disclosure are set forth in the appended claims. A preferred mode of use, further objectives and advantages thereof, will be best understood by reference to the following detailed description of illustrative embodiments when read in conjunction with the accompanying figures, wherein:

FIG. 1 is a perspective view of the nozzle apparatus assembly in accordance with an illustrative embodiment;

FIG. 2 is a lateral view of the nozzle apparatus assembly of FIG. 1 but with the housing body removed;

FIG. 3 is a cross-sectional view of the nozzle apparatus assembly of FIG. 1 in accordance with an illustrative embodiment;

FIG. 4 is an exploded view of the nozzle apparatus assembly in accordance with an illustrative embodiment;

FIG. 5 is an exploded perspective view of the nozzle apparatus assembly in accordance with an illustrative embodiment;

FIGS. 6A and 6B are exploded perspective views of a friction brake assembly in accordance with an illustrative embodiment;

FIG. 7 is a perspective view of the nozzle apparatus assembly in a partially disassembled configuration in accordance with an illustrative embodiment;

FIGS. 8A, 8B, and 8C are alternate views of a data logger in accordance with an illustrative embodiment;

FIG. 9 is a plan view of a data logger in accordance with another illustrative embodiment; and

FIG. 10 is a perspective view of the nozzle apparatus assembly in a partially disassembled configuration showing components of a renewable power supply in accordance with another illustrative embodiment.

### DETAILED DESCRIPTION

Objects of this disclosure recognize the need for a nozzle apparatus assembly that can capture, store, and transmit operational data, such as rotational speed data, temperature data, time data, and/or location data. The operational data can be used to establish operating parameters, determine service intervals, calculate return on investment for tools and services, map out sewer systems, etc., which can be used to create maintenance schedules and improve the operation of the nozzle apparats assembly.

Another object of the disclosure is to reduce the speed of rotation of a nozzle head and a tubular nozzle shaft rotatably mounted within an outer housing of the nozzle apparatus assembly. Rotational speed reduction can reduce wear and heat generation at the moving parts within the nozzle apparatus assembly.

Another object of the disclosure is to provide a nozzle with a speed retarding mechanism having a friction-generation mechanism that provides lower braking forces at lower rotational speeds and torque inputs, and higher braking forces at higher rotational speeds and torque inputs.

Another object of the disclosure is to provide a durable rotation speed retarding mechanism for the rotating spray head in an elongated small diameter high pressure water spray assembly.

Another object of the disclosure is to provide an improved speed retarding mechanism for a rotating nozzle member of a small diameter high pressure spray nozzle assembly using a mechanism incorporating one or more centrifugal force converters that converts a centrifugal force into an axial force usable for nozzle head speed retardation control.

Another object of the disclosure is to provide a rotation speed retarding mechanism that can operate in the absence of a lubricating fluid filling the enclosable chamber.

The nozzle assembly apparatus includes a generally cylindrical housing body forming a relatively stationary reference structure with respect to a coaxial, rotatable tubular nozzle shaft that has an input end in sealed relationship with a connecting high pressure liquid input source, e.g., a high-pressure lance, via an internally threaded portion for receiving the threaded end of the high-pressure liquid input source, e.g., cone-and-thread or conventional pipe threads.

The cartridge assembly contains the high working pressure of the high-pressure spray liquid at the inlet end of the nozzle apparatus assembly and prevents the escape of high-pressure liquid from the intended liquid flow path passage into the inlet end of the tubular nozzle member. The cartridge assembly used permits easy replacement of a single plastic seal member with O-ring when it is worn at a small fraction of the cost of replacement of the durable seat. The durable seat, which can be formed from carbide, is pressed axially against and rotates with the nozzle shaft during operation of the spray nozzle apparatus. The cartridge assembly depicted herein is exemplary and should not be deemed limiting.

The cartridge assembly comprises the inlet seat housing, the axially slidable seal, and the durable seat. The design of the cartridge assembly provides a very effective seal at low cost because of the simplicity of configuration of these three principal parts and their manner of retention, and replacement when necessary, after wear, during the life of the nozzle structure. Wear of 50% of the axially slidable seal, which can be formed from plastic, is tolerated without degradation of sealing by this assembly.

The enclosable chamber is sealed at the discharge end of the housing body by a removable front cap and an annular shaft seal between the outer surface of the tubular nozzle shaft and an inner surface of the removable front cap. The inlet end of the enclosable chamber is sealed by a shaft seal between the tubular nozzle shaft and a necked portion of the housing body.

The various internal elements in the enclosable chamber of the nozzle apparatus assembly are kept in relatively fixed axial positions by means including the removable front cap, which, when properly seated, pushes all such elements toward the inlet end of the housing body where the inlet end radial bearing abuts an inwardly-extending housing body shoulder. A wave spring accommodates the tolerance stack and biases the elements forward toward the discharge end. Ball bearings form axially spaced load distributing bearing means between a rotating tubular nozzle shaft and an inner cylindrical surface of a nozzle housing body. The bearings rotatably support the shaft coaxially within the housing body and prevent axial movement of the tubular nozzle shaft when subjected to high forwardly directed thrust forces from internal high liquid pressures at rotary seal members in the nozzle assembly.

The nozzle apparatus assembly described in this disclosure is intended for use in a high-pressure range of approximately 2,500-44,000 psi. Embodiments of the frictional braking assembly described herein can prevent overspeeding, i.e., the speed can be maintained in the range of about 500-5,000 rpm with an optimal speed of about 2,000 rpm for a spraying operation. Without practical maximum speed control, a runaway rotary nozzle can reach several thousand rpm which can detrimentally affect the spraying function and also rapidly increase wear of seals, bearings and other operating parts of nozzle apparatus assembly. The frictional braking assembly is contained in an enclosable chamber which encloses ball bearing means for rotatably supporting the rotatable tubular nozzle shaft that carries the spray liquid to the nozzle head. This enclosable chamber is sealed to protect the bearings and speed control mechanisms from any liquid which might escape from the spray liquid passages within the housing body as well as any liquid from the environment.

The data logger housed within the enclosable chamber can collect operational data using devices, e.g., sensors, embedded in or on a substrate, e.g., a printed circuit board (PCB), all of which may be encased in a casting formed from potting compound. Examples of the operational data can include rotation data, temperature data, date and time, and location data. In some embodiments, the data logger can include wireless charging and/or wired or wireless means of communication, which can allow the operational data to be uploaded into an online portal via an app or a web app for storage, processing, and analytics. The operational data can be used to optimize operational parameters. For example, rotation data can be used to calculate rotational speed of the rotary nozzle, which can then be used to tune in jetting to match the pump, optimize feed rate while obviating stripping, optimize service interval, determine when to change nozzles, calculate return on investment for the rotary nozzle and/or service, determine run time, estimate water usage, etc. Temperature data, along with the rotation data, can be used to determine the pump capacity for cold weather jobs. Location data can be used to map out a city sewer system, which can be used to identify and locate pipes, and determine what sections have been cleaned. The data can be used to create a preventive maintenance schedule instead of relying on reactive maintenance.

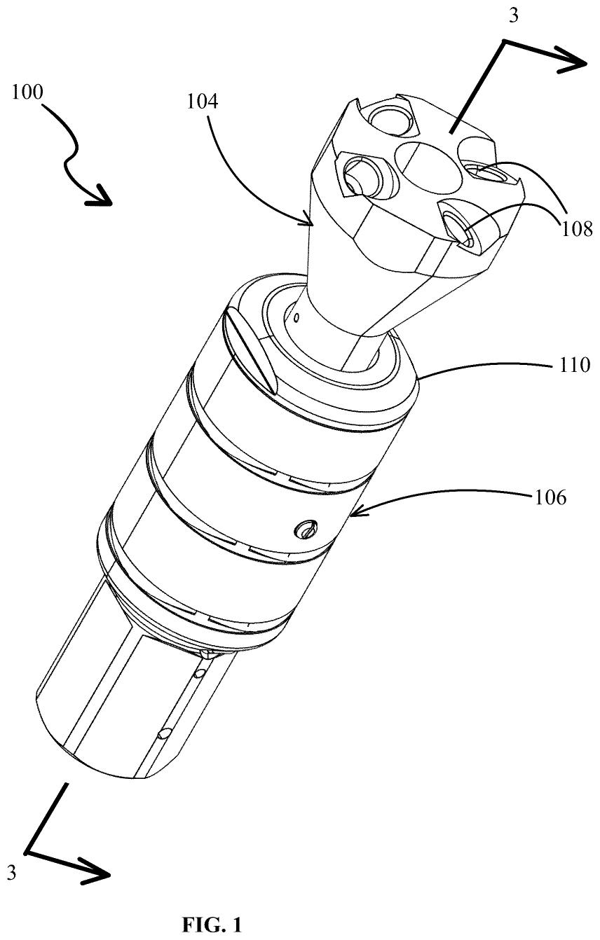

FIGS. 1-5 are various views of a high-pressure, liquid nozzle apparatus assembly 100 that can be connected to a source of high-pressure liquid, such as a spray lance. Generally, the discharge of pressurized liquid from a set of canted discharge nozzles 108 at the discharged end of the nozzle head 104 causes the nozzle head 104 to rotate during operation. As used herein, the term “set” means one or more. Thus, a set of canted discharge nozzles can be a single canted discharge nozzle, or two or more canted discharge nozzles. Operational data is captured by a data logger 800 during use of the nozzle apparatus assembly 100.

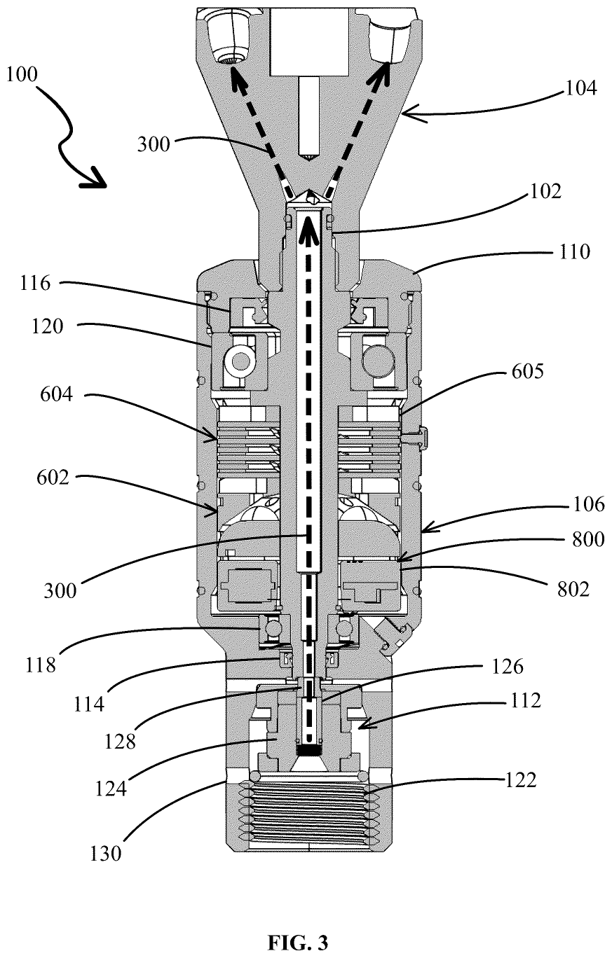

FIG. 1 is a perspective view of the nozzle apparatus assembly in accordance with an illustrative embodiment. The nozzle apparatus 100 is formed from an elongated cylindrical housing body 106 within which is rotatably mounted a tubular nozzle shaft 102 (shown in more detail in FIGS. 3-6 that follow). The tubular nozzle shaft 102 is fixedly attached to a nozzle head 104 so that rotation of the nozzle head 104 causes rotation of the tubular nozzle shaft 102. Rotation of the nozzle head 104 is caused by the discharge of pressurized liquid, i.e., jet streams, from a set of discharge nozzles 108. As used herein, the term “set” means one or more. Thus, the set of discharge nozzles 108 can be a single discharge nozzle or two or more discharge nozzles. In the non-limiting embodiment presented in this disclosure, the set of discharge nozzles 108 includes four discharge nozzles 108 arranged regularly about the discharge end of the nozzle head 104.

In a non-limiting embodiment, the set of discharge nozzles 108 are canted to impart a jet reaction torque, i.e., rotation, on the nozzle head 104 and also on the tubular nozzle shaft 102, which makes the nozzle head 104 and the tubular nozzle shaft 102 self-rotating. The direction of self-rotation in this illustrated embodiment is clockwise when looking into the discharge end of the nozzle assembly 100. The direction of rotation helps to maintain the nozzle head 104 screwed securely into the tubular nozzle shaft 102.

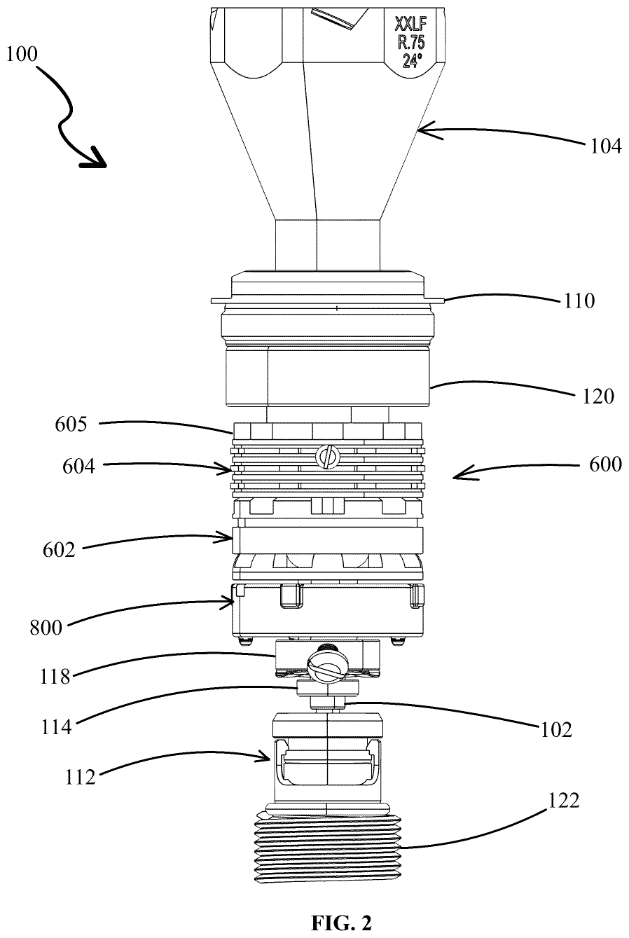

FIG. 2 is a lateral view of the nozzle apparatus assembly of FIG. 1 but with the housing body removed. At the inlet end of the nozzle apparatus assembly 100 is a cartridge assembly 112 configured to connect a source of high-pressure liquid, e.g., a lance hose (not shown), to a tubular nozzle shaft 102, which is in turn connected to nozzle head 104. As previously discussed, flow of pressurized fluid through a fluid flow path of the nozzle apparatus assembly 100 causes the tubular nozzle shaft 102 and the nozzle head 104 to rotate. The fluid flow path is shown in more detail in FIG. 3 and is represented by a series of arrows 300 passing through the tubular nozzle shaft 102 and branching out in the nozzle head 104, which connects the inlet end of the nozzle assembly apparatus 100 to canted discharge nozzles 108 at its discharge end.

Disposed around the tubular nozzle shaft 102 is a friction brake assembly 600 that retards the rotational speed of the tubular nozzle shaft 102 and the nozzle head 104. As will be discussed in more detail in the figures that follow, the friction brake assembly 600 includes a set of centrifugal force converters 602 that converts a centrifugal force into an axial force that increases a braking force, i.e., frictional forces, imparted to a set of brake disks 604.

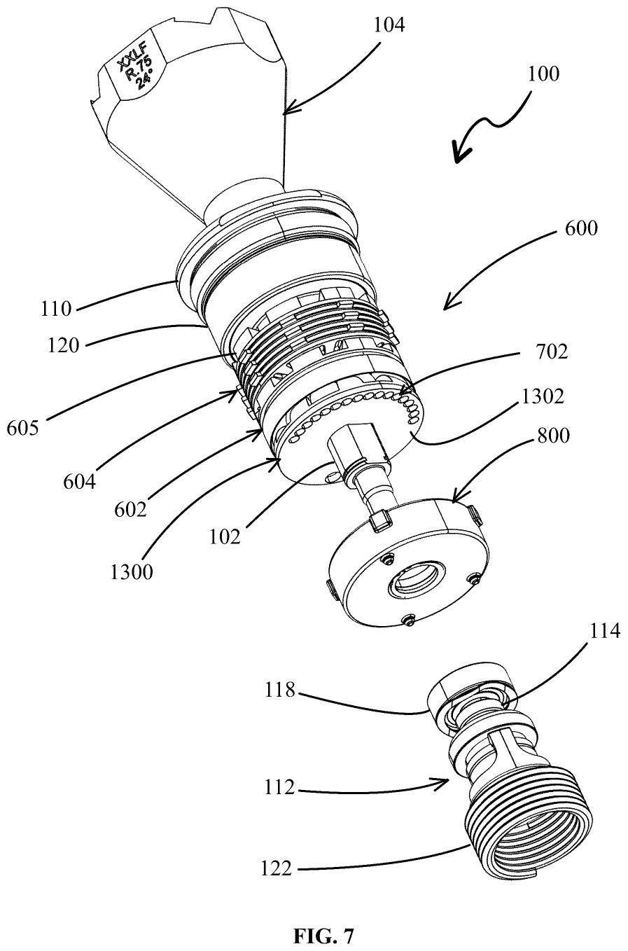

Also disposed about the tubular nozzle shaft 102 is a data logger 800, which is shown and described in more detail in FIGS. 7, 8A, 8B, 8C, and 9. The data logger 800 is configured to gather operational data that can be transmitted to a remote computing device for storage, processing and/or analytics. The operational data can be used for improving the operation of the nozzle apparatus assembly 100 and creating optimized maintenance schedules.

The tubular nozzle shaft 102, the friction brake assembly 600, and the data logger 800 are housed within an enclosable chamber formed by the housing body 106 and sealed by a front cap 110. As can be seen in the lateral cross-sectional view of the nozzle apparatus assembly 100 in FIG. 3, a discharge end of the tubular nozzle shaft 102 extends out of the enclosable chamber from an aperture in the front cap 110. The discharge end of the tubular nozzle shaft 102 is coupled to the inlet end of the nozzle head 104.

FIG. 3 is a cross-sectional view of the nozzle apparatus assembly of FIG. 1, taken along line 3-3, in accordance with an illustrative embodiment. The housing body 106 defines an enclosable chamber that is further sealed on opposing ends by shaft seals, i.e., a rear shaft seal 114 and a front shaft seal 116. The rear shaft seal 114 seals against the tubular nozzle shaft 102 and the housing body 106 and the front shaft seal 116 seals against the tubular nozzle shaft 102 and the front endcap 110 that is secured to the discharge end of the housing body 106.

The tubular nozzle shaft 102 is rotatably mounted within the housing body 106 by ball bearings mounted just inside the rear shaft seal 114 and the front shaft seal 116. In particular, the discharge end of the tubular nozzle shaft 102 is rotatably supported against the housing body 106 by the discharge end ball bearing 118, which can be angular contact ball bearings in a non-limiting embodiment, and the inlet end of the tubular nozzle shaft 102 is rotatably supported by the inlet end ball bearing 120 against the housing body 106.

The axial position of the tubular nozzle shaft 102 is also fixed within the housing body 106 by the discharge end ball bearing 118 and the inlet end ball bearing 120. In particular, axial movement in the direction of the discharge end is prevented by an outwardly extending annular shoulder that abuts against the inner race of the discharge end ball bearing 118, which has its outer race abutting the front endcap 306. Axial movement in the direction of the inlet end is prevented, at least in part, by a stepped shoulder abutting the inner race of the rear ball bearing 114, which abuts against a wave spring compressed against an inner shoulder of the housing body 106.

A threaded interface 122 and/or a cartridge assembly 112 is located at the inlet end of the nozzle assembly apparatus 100 for removably engaging a high-pressure liquid input source, e.g., a fluid hose or lance (not shown), by conventional means, including but not limited to a cone- and thread connector, or conventional pipe threads. The cartridge assembly 112 includes an inlet seat housing 124 providing a connection interface with a terminal end of the high-pressure liquid input source, which is a smooth, conical surface in the depicted embodiment for engaging a cone-and-thread connector. Housed at least partially inside of the inlet seat housing 124 is an axially slidable seal 126 abutting a hard, durable seat 128 that engages the inlet end of the tubular nozzle shaft 102. In a non-limiting embodiment, the durable seat is formed from carbide.

When a high-pressure liquid input source is secured in the inlet end of the housing body 106, a sealed connection is formed against the conical entrance inlet seat housing 124. A pressurized liquid introduced into the cartridge assembly 112 is conveyed through the fluid flow path 300 extending through the tubular nozzle shaft 102 and the nozzle head 104 before being discharged through the canted discharge nozzles 108. Any leakage of high-pressure liquid outside of the axially slidable seal 126 and the durable seat 128 can escape through weep passages 130 in the housing body 106, shown in FIGS. 1 and 3.

The outside wall of the axially slidable seal 126 fits snugly against the wall of inlet seat housing 124. An O-ring seal disposed within an annular groove in the axially slidable seal 126 not only provides additional sealing means between the outer surface of the axially slidable seal 126 and the inlet seat housing 124, but also aides in holding the axially slidable seal 126 in position against rotation as the axially slidable seal 126 is sealed against the durable seat 128. In the depicted embodiment, the durable seat 128 rotates with the tubular nozzle shaft 102 during operation of the nozzle apparatus assembly 100. As the end of the axially slidable seal 126 wears where it contacts the durable seat 128, an axial force directed towards the discharge end, e.g., by a spring and/or a liquid pressure from the pressurized liquid flowing into the fluid flow path 300, assures sealed continuity at the input end of the tubular nozzle shaft 102.

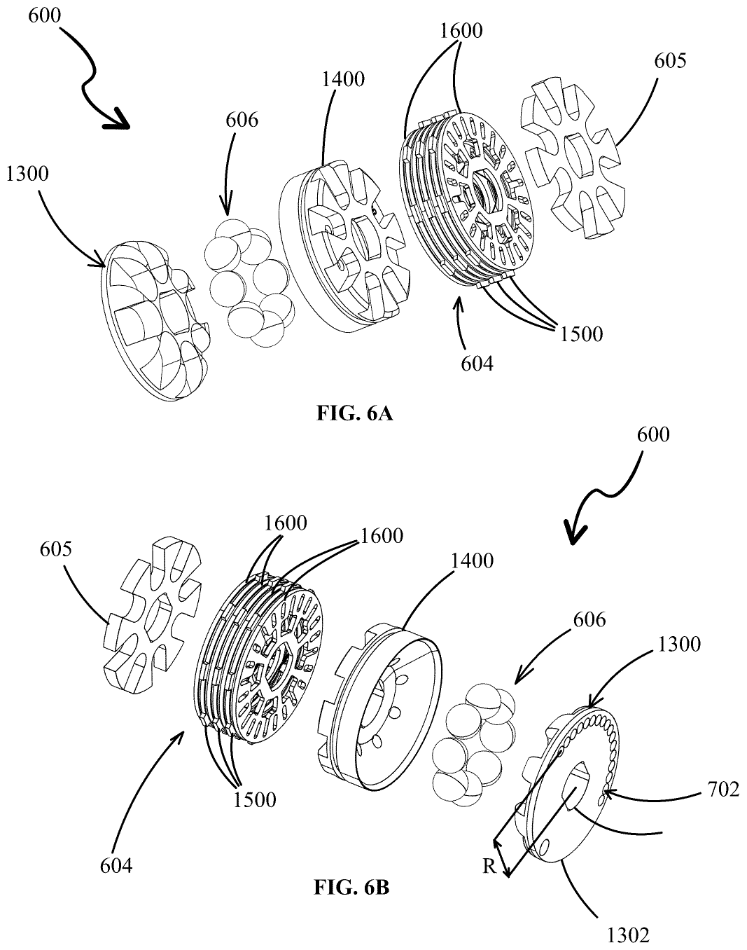

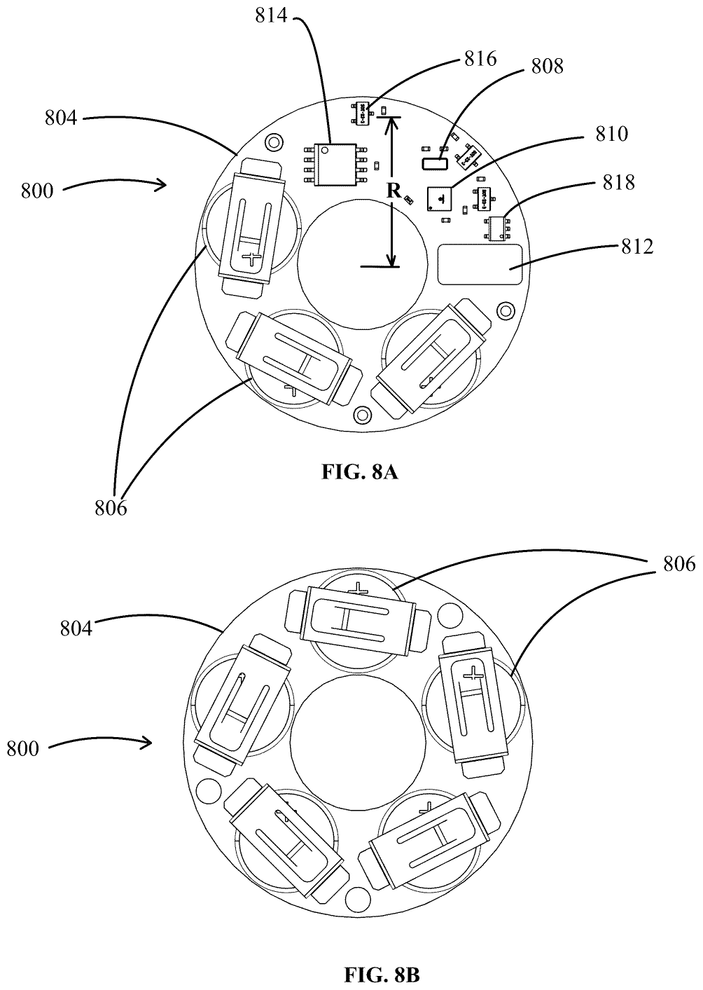

Overspeed rotation of the tubular nozzle shaft 102 and the nozzle head 104 is prevented by the frictional brake assembly 600, as described in more detail in FIGS. 6A and 6B, and operational data can be captured by a data logger that is shown and described in more detail in FIGS. 8A, 8B, and 8C.

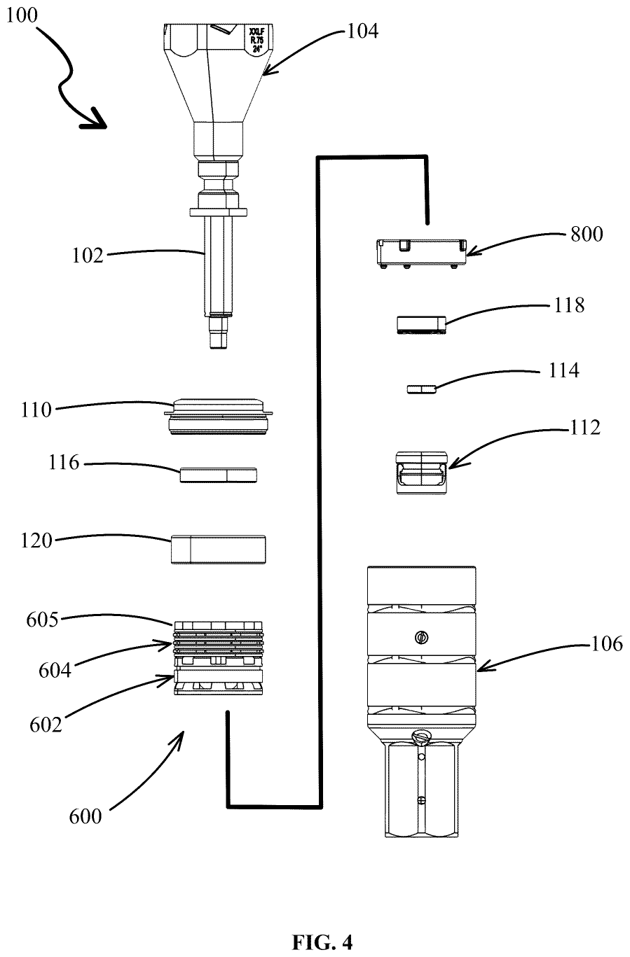

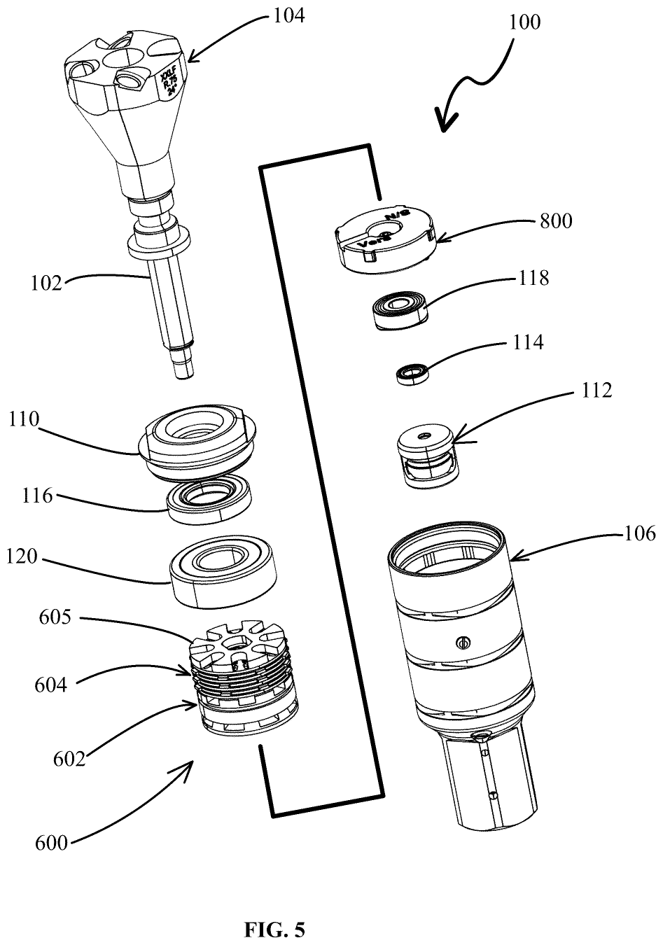

FIGS. 4 and 5 are various exploded views of the nozzle apparatus in accordance with an illustrative embodiment. In particular, FIG. 4 is an exploded lateral view of the nozzle apparatus assembly, and FIG. 5 is an exploded perspective view of the nozzle apparatus assembly.

FIGS. 6A and 6B are exploded views of the friction brake assembly of the nozzle apparatus in accordance with an illustrative embodiment. The friction brake assembly 600 is configured to reduce the rotational speed of the nozzle head 104 and tubular nozzle shaft 102 by converting a centrifugal force into an axial force that can reduce the rotational speed of the nozzle apparatus assembly 100. The operational principles of the friction brake assembly 600 is described in more detail in U.S. Application No. 63/619,625, which is incorporated by reference herein and described briefly below for ease of reference.

The friction brake assembly 600 is generally formed from a set of centrifugal force converters 602 and a set of brake disks 604. In the depicted embodiment, the set of centrifugal force converters 602 includes one centrifugal force converter and the set of brake disks 604 includes a plurality of rotor disks 1600 and lined friction disks 1500 arranged in alternating fashion. The centrifugal force converter 602 is slidably engaged to the tubular nozzle shaft 102 but rotationally fixed relative to the tubular nozzle shaft 102 so that the rotation of the tubular nozzle shaft 102 causes the centrifugal force converter 602 to rotate in concert with the tubular nozzle shaft 102. At least some of the brake disks 604, e.g., rotor disks 1600, are also slidably engaged to the tubular nozzle shaft 102 and rotationally fixed relative to the tubular nozzle shaft 102 so that at least some of the brake disks 604 can rotate in concert with the tubular nozzle shaft 102. The remaining portion of the brake disks 604, e.g., lined friction disks 1500, are coaxially aligned about the tubular nozzle shaft 102 but slidably engaged to the housing body 300 and rotationally fixed relative to the housing body 300. By allowing some of the brake disks 604 to rotate with the rotating tubular nozzle shaft 102 while the remaining brake disks 604 are maintained rotationally fixed, the amount of friction between the brake disks 604 can be increased in order to generate a braking force to slow down the rotation of the tubular nozzle shaft 102 and the nozzle head 104.

Each of the centrifugal force converters 602 is formed from one or more centrifugally responsive weights 606 that travels radially outwardly along the surface of an idler spider 1300 in the presence of a centrifugal force. In the depicted embodiment, the centrifugally responsive weights 606 are ball bearings formed from a dense material, such as metal or a metallic alloy. As the ball bearings travel radially outwardly, the ramped disk 1400 engages the ball bearings to convert at least some of the centrifugal force of the ball bearings into an axial force that compresses the brake disks 604, which reduces the rate of rotation of the tubular nozzle shaft 204 and the attached nozzle head 202. Heat generated by the frictional forces between the brake disks 604 can be drawn away by heat sink 605, which is positioned between the brake disks 604 and a shoulder the tubular nozzle shaft 102.

A set of axially oriented channels is disposed regularly throughout the inner surface of the housing body 106. Each of the set of channels is configured to receive a corresponding tooth from a brake disk, e.g., one or more lined friction disks 1100 in the depicted embodiments (or one or more rotor disks in an alternate embodiment where the lined friction disks are rotationally fixed to the nozzle shaft 102 and allowed to rotate relative to the rotor disks, which are rotationally fixed to the housing body 106). In a non-limiting embodiment, when a toothed, lined friction disk 1100 is mounted within the enclosable chamber, each of the teeth is engaged within a corresponding channel, which prevents rotational movement of the lined friction disk 1100 within the housing body 106 but permits axial movement of the lined friction disk 1100.

In some embodiments, the enclosable chamber is run dry, and the bearings housed within the enclosable chamber can be sealed with internal lubrication. In other embodiments, the enclosable chamber can be filled with a liquid or lubricant, which can help pull heat from the friction brake assembly, i.e., the brake disks, to the enclosable chamber to increase heat dissipation. If the enclosable chamber is filled with a lubricant, then the nozzle apparatus assembly can use open bearings.

The friction brake assembly 600 can be replaced in favor of a different braking system, such as a fluid brake assembly described in more detail in U.S. Application No. 63/610,309, incorporated by reference herein, or omitted entirely.

FIG. 7 is a perspective view of the nozzle apparatus assembly in a partially disassembled configuration in accordance with an illustrative embodiment. The housing body is omitted for the sake of clarity.

The data logger 800 is shown separated from the friction brake assembly 600 to expose the set of magnets 702 embedded into the base 1302 of the idler spider 1300. In the non-limiting embodiment depicted in FIG. 7, the set of magnets 702 includes 17 magnets arranged in an arc, each separated from the center of the base 1302 by a radius R (shown in FIG. 6B). At the center of the base 1302 is an aperture keyed to the transverse cross-sectional shape of the nozzle shaft 102 so that the rotation of the nozzle shaft 102 can be transferred to the idler spider 1300. Rotation of the idler spider 1300 causes the magnets 702 to travel in a circular path with a radius R that coincides with the position of a rotation sensor 816, e.g., a Hall Effect sensor, housed within the data logger 800. As the idler spider 1300 rotates, the magnets 702 travel along the circular path, which generates a rotating magnetic field detectable by the rotation sensor 816. The rotating magnetic field can be used to detect rotation of the idler spider 1300 and thus the nozzle shaft 102.

The data logger 800 has a central aperture that is large enough to allow the nozzle shaft 102 to pass through the data logger 800 and rotate without contacting the sidewalls of the data logger 800. Rotation of the data logger 800 is prevented in the housing body 106 by one or more tabs 801 extending outwardly from the outside sidewall of the casting 802. The tabs 801 are sized to be received in the same channels (not shown) disposed on the inner surface of the housing body 106 which receive the outwardly extending teeth of one or more brake disks 604, e.g., the lined friction disks 1500, to prevent the one or more brake disks 604 from rotating.

FIGS. 8A, 8B, and 8C are alternate views of a data logger in accordance with an illustrative embodiment. In particular, FIGS. 8A and 8B are plan views of the two sides of the data logger 800, and FIG. 8C is a perspective view of the data logger 800. In each of these views, the data logger 800 is shown without casting 802 for the sake of simplicity. The casting 802 is a protective layer formed from a potting compound that encapsulates the electronic components for protection against water and/or oil, as well as impacts. The potting compound can be a liquid polymer, e.g., urethane or epoxy, which can harden into the casting 802 over time.

Although the embodiments depicted herein show a data logger 800 protected by a casting 802, in another embodiment the electronic components of the data logger 800 can be protected by a sealed or otherwise waterproof or water-resistant housing that can be optionally filled with a potting compound. In a particular embodiment, the housing can also serve as the mold that receives the potting compound that forms the casting 802.

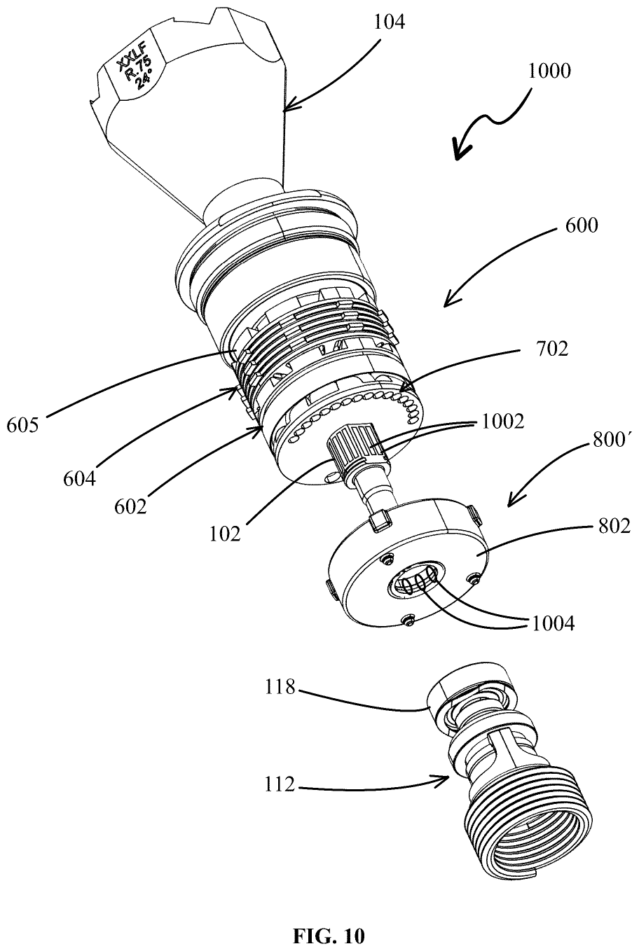

The data logger 800 includes a substrate 804 on which the electronic components are disposed. In the depicted embodiment, the substrate 804 is a printed circuit board that includes vias and traces (not shown) for providing electrical connections between the electronic components. The electronic components are powered by a power supply 806 that is also disposed on the substrate 804. In the depicted embodiment, the power supply 806 is a plurality of batteries secured to both sides of the substrate 804. In another embodiment, the power supply 806 can include a form of renewable energy harvested from the kinetic energy generated by the rotation of the nozzle shaft 102 and nozzle head 104. For example, the power supply 806 can include a plurality of coils positioned to generate electricity from a rotating magnetic field caused by the rotation of the magnets 702, or the rotation of magnets dedicated to power generation (as shown and described in more detail in FIG. 10). The electricity can be stored in one or more rechargeable batteries or supercapacitors.

The data logger 800 can detect temperature data using a temperature sensor 808. The temperature data can be stored in a data storage device 810. The data storage device 810 can represent any structure(s), e.g., flash memory, capable of storing and facilitating retrieval of information, such as operational data, program code, and/or other suitable information on a temporary or permanent basis.

Data stored in the data storage device 810 can be periodically or aperiodically, e.g., upon request, transmitted to a remote computing device, e.g., a phone, table, or laptop (not shown) via communications interface 812, which can be configured to provide the nozzle apparatus assembly 100 with wired or wireless communications capabilities. In a first non-limiting embodiment, the communications interface 812 is header configured to receive a wired connector connected to the remote computing device. The header can be sealed with a header cap to protect the connection ports. In a second non-limiting embodiment, the communications interface 812 is a wireless communications device allowing data transfer over device-to-device communications protocols, such as BLUETOOTH® and/or Near-Field Communications (NFC), among others. In yet another embodiment, the data logger 800 can communicate via both wireless and wired communications. In one example, the communications interface 812 can include wired and wireless communications capabilities. In another example, the communications interface 812 can include wired communications capabilities and the data logger 800 can include a microcontroller 814 that can include integrated wireless communications capabilities.

To facilitate the transmission of wireless signals from within the data logger 900, the housing body 106 may include one or more slot openings positioned adjacent to the communications interface 812 to allow for signal transmission through the housing body 106. The slot openings can be removably or permanently sealed to prevent the influx of water, oil, and/or debris into the nozzle apparatus assembly 100. For example, the seal can be permanently sealed by a non-metallic material that allows for transmission of wireless signals, or removably sealed by a plug or seal so that the slot openings can be exposed only when syncing between the data logger 900 and the remote computing device. Alternatively, the housing body may include wire or antenna penetrations passing through the housing body 106 capable of interfacing with the communications interface 812 to allow for signal transmission through the housing body 106. In another example, the communications interface 812 can include a transducer that converts electrical signals into an acoustic signal that can be transmitted through the housing body 106, received by an external transducer and then converted back into an electrical signal.

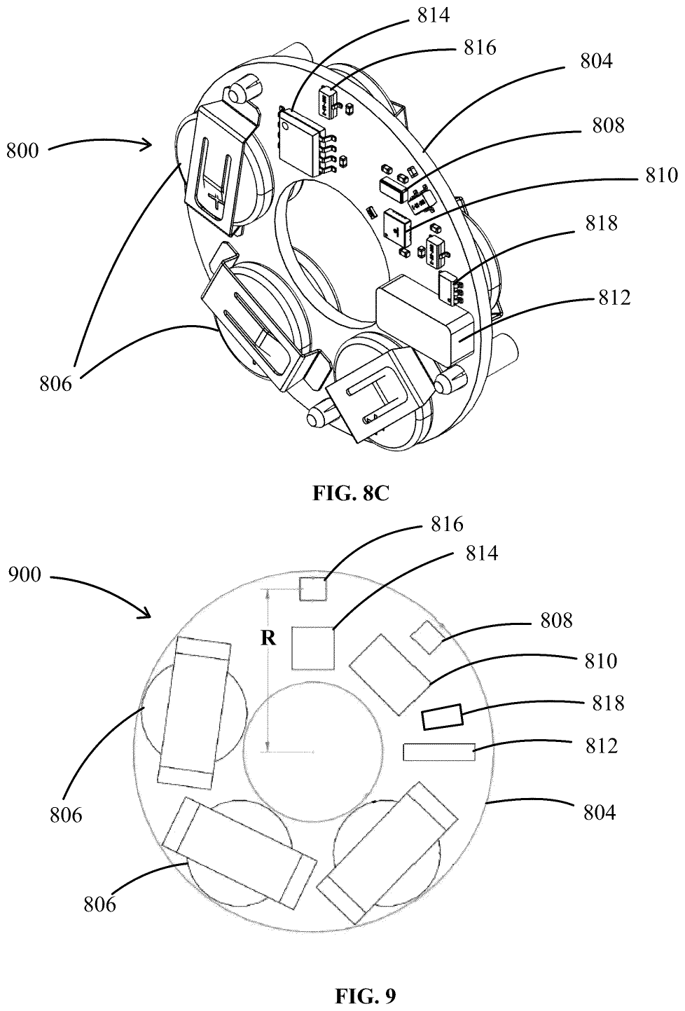

The data logger 800 can detect rotation of the nozzle shaft 102 and/or nozzle head 104 with a rotation sensor 816. In the non-limiting embodiment of FIG. 9, the rotation sensor 816 is a Hall Effect sensor that is positioned at a radial distance R from the center of the data logger 900. The radial distance R in FIG. 8A corresponds to the same radial distance R in FIG. 6B, so that rotation of the idler spider 1300 causes the magnets 702 to travel in a circle with radius R that coincides with the placement of the Hall Effect sensor. The Hall Effect sensor can detect rotation of the nozzle shaft 102 by detecting a change in magnetic field. Although the magnets 702 are shown embedded into the idler spider base 1302 of the idler spider 1300, in another embodiment, the set of magnets 702 can be embedded in any rotating element is positioned to abut the data logger 800. For example, in another embodiment, the magnets 702 may be embedded in the ramped disk 1400 in the event that the placement of the ramped disk 1400 and the idler spider 1300 are reversed. In another embodiment, the magnets 702 can be embedded within the nozzle shaft 102 and the Hall Effect sensor can be repositioned to the inner circumference of the substrate 804. In yet another embodiment where space inside the housing body 106 is limited and unable to accommodate a data logger 800, the components of the data logger 800 can be incorporated into the front cap 110 and the set of magnets 702 can be embedded into the nozzle head 104 or a portion of the nozzle shaft 102 adjacent to the front cap 110, and all or a portion of the front cap 110 can be formed from a material that facilitates penetration by magnetic fields.

While the rotation sensor 816 is described as a Hall Effect Sensor, other rotation sensors can be used instead of or in addition to the magnets 702 and the Hall Effect sensor 816 described herein. For example, the nozzle apparatus assembly 100 can also include rotary encoders, optical encoders, magnetic encoders, resistive sensors, or capacitive sensors.

Signals generated by the Hall Effect sensor can be received by the microcontroller 814 to calculate a speed of rotation of the nozzle shaft 102 with reference to time maintained by a timer. The timer can be integrated with the microcontroller 814 or other electronic component, such as a GPS module in the event the data logger 800 is configured with GPS technology. The rotational speed data can be stored in the data storage device 810 and periodically or aperiodically transmitted to a remote computing device, e.g., a phone, table, or laptop (not shown) via communications interface 812 as previously described. In some embodiments, the raw data captured by the rotation sensor 816 is stored in the data storage device 810 and then transmitted to a remote computing device by the communications interface 812. The remote computing device (or another that is communicatively coupled to the remote computing device) can process the raw data to calculate the speed of rotation.

Location data of the nozzle apparatus assembly 100 can be generated by a location device 818. The location data can be stored in data storage device 810 and then transmitted to a remote computing device via communications interface 812. The location device 818 can implement currently existing or later developed technologies. For example, in a non-limiting embodiment the location device 818 can be a GPS module for determining location based on GPS signals. In another embodiment, the location data can be calculated without a dedicated location device 818. For example, location data can be calculated based on signals transmitted to and from the communications interface 812 with communications infrastructure having known locations, such as cell towers or WI-FI points. To improve signal transmission through the housing body 106, the location device 818 can be positioned proximate to the communications interface 812 and the slotted openings of the housing body 106 as previously described.

FIG. 9 is a plan view of a data logger in accordance with another illustrative embodiment. The data logger 900 is shown without the protective casting for the sake of simplicity. The data logger 900 is similar to the data logger 800 in FIG. 8 but differs in the placement of certain electronic components on the substrate 804.

FIG. 10 is a perspective view of the nozzle apparatus assembly in a partially disassembled configuration showing components of a power supply in accordance with another illustrative embodiment. Additionally, the housing body is omitted for the sake of clarity.

The nozzle apparatus assembly 1000 in FIG. 10 is powered, at least in part, by electricity generated by the rotation of the nozzle shaft 102 and nozzle head 104. A series of magnets 1002 arranged around the nozzle shaft 102 produces series of rotating magnetic fields as the nozzle shaft 102 rotates, which induces current flow in the plurality of coils 1004 disposed about the central aperture of the casting 802 of the data logger 800′. In some embodiments, the plurality of coils 1004 can be partially or wholly encased by the casting 802 of the data logger 800′ and electrically connected to one or more energy storage devices, such as rechargeable batteries or supercapacitors (not shown).

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this disclosure has been particularly shown and described with reference to preferred embodiments, it will be understood by those skilled in the art that various changes in form and detail may be made therein without departing from the spirit and scope of the disclosure. The inventors expect skilled artisans to employ such variations as appropriate, and the inventors intend the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A nozzle apparatus assembly comprising:
a housing body;
a tubular nozzle shaft rotatably mounted within the housing body;
a nozzle head coupled to the tubular nozzle shaft, wherein:
the tubular nozzle shaft and the nozzle head define a portion of a fluid pathway extending from an inlet end of the housing body to a set of directional nozzles disposed at a discharge end of the nozzle head, and
the tubular nozzle shaft and the nozzle head are configured to rotate together in response to a discharge of a pressurized liquid from the set of directional nozzles; and
a data logger housed within the housing body, wherein the data logger includes:
a rotation sensor configured to detect rotation of the tubular nozzle shaft or the nozzle head;
data storage device configured to store rotation data captured by the rotation sensor or rotational speed data calculated from the rotation data and time data; and
a communications interface configured to transmit the stored data to a remote computing device.

2. The nozzle apparatus assembly of claim 1, wherein:
the data logger includes a microcontroller communicatively coupled to the rotation sensor,
the microcontroller is configured to calculate the rotational speed data based on the rotation data.

3. The nozzle apparatus assembly of claim 1, wherein:
the data logger includes a temperature sensor configured to capture temperature data of the tubular nozzle shaft,
the data storage device is configured store the temperature data, and
the communications interface is configured to transmit the temperature data to the remote computing device.

4. The nozzle apparatus assembly of claim 3, wherein the rotation sensor, the temperature sensor, the communications interface, and the data storage device are disposed on a substrate and encased in a potting compound.

5. The nozzle apparatus assembly of claim 3, wherein:
the data logger includes a location device configured to capture location data of the nozzle apparatus assembly,
the data storage device is configured to store the location data, and
the communications interface is configured to transmit the location data to the remote computing device.

6. The nozzle apparatus assembly of claim 3, wherein the data logger includes a power supply configured to provide power for one or more of the rotation sensor, the temperature sensor, and the communications interface.

7. The nozzle apparatus assembly of claim 6, wherein the power supply further comprises:
a set of magnets configured to travel in a circular path within the housing body and around an axis of rotation defined by the tubular nozzle shaft, wherein rotation of the tubular nozzle shaft and the nozzle head generates a rotating magnetic field within the housing body from the set of magnets; and
a plurality of wire coils configured to generate electricity from the rotating magnetic field to provide the power.

8. The nozzle apparatus assembly of claim 1, wherein the rotation sensor comprises a Hall Effect sensor, the nozzle apparatus assembly further comprising:
a set of magnets configured to travel in a circular path within the housing body and around an axis of rotation defined by the tubular nozzle shaft, wherein the circular path coincides with a position of the Hall Effect sensor; and
a microcontroller communicatively coupled to the Hall Effect sensor, wherein the microcontroller generates the rotational speed data based on signals received from the Hall Effect sensor.

9. The nozzle apparatus assembly of claim 2, wherein:
the microcontroller includes a timer that captures the time data, and
the microcontroller calculates the rotational speed data based on the time data and the rotation data.

10. The nozzle apparatus assembly of claim 5, wherein:
the location device is a GPS receiver that can maintain the time data, and
the rotational speed data is calculated based on the time data and the rotation data.

11. The nozzle apparatus assembly of claim 10, wherein the data logger includes a microcontroller that calculates the rotational speed data.

12. The nozzle apparatus assembly of claim 1, wherein the communications interface is a connection port configured to receive a wired communications link.

13. The nozzle apparatus assembly of claim 1, wherein the communications interface is a wireless communications device configured to transmit data over one or more wireless communications links.

14. A data logger for capturing operational data of a nozzle apparatus assembly, the data logger comprising:
a printed circuit board (PCB);
a rotation sensor disposed on the PCB and configured to detect rotation of the tubular nozzle shaft or the nozzle head;
a microcontroller disposed on the PCB and communicatively coupled to the rotation sensor, wherein the microcontroller is configured to calculate rotational speed data based rotation data captured by the rotation sensor;
a data storage device disposed on the PCB and configured to store the rotational speed data; and
a communications interface disposed on the PCB and configured to transmit the rotational speed data to a remote computing device.

15. The data logger of claim 14, further comprising:
a temperature sensor disposed on the PCB and configured to capture temperature data of the tubular nozzle shaft, wherein:
the data storage device is configured store the temperature data, and
the communications interface is configured to transmit the temperature data to the remote computing device.

16. The data logger of claim 15, wherein the rotation sensor, the temperature sensor, the data storage device, the communications interface, the microcontroller, and the PCB are encased in a potting compound.

17. The data logger of claim 14, further comprising:
a location device configured to capture location data, wherein:
the data storage device is configured to store the location data, and
the communications interface is configured to transmit the location data to the remote computing device.

18. The data logger of claim of claim 15, further comprising:
a power supply configured to provide power for one or more of the rotation sensor, the temperature sensor, the microcontroller, and the communications interface.

19. The data logger of claim 18, wherein the power supply further comprises:
a plurality of wire coils configured to generate the power from a rotating magnetic field of the nozzle apparatus assembly.

20. The data logger of claim 14, wherein the rotation sensor comprises a Hall Effect Sensor positioned to coincide with a circular path taken by a set of magnets within a housing body and around an axis of rotation defined by a tubular nozzle shaft of the nozzle apparatus assembly.
